(19) United States
(12) Patent Application Publication
(10) Pub. No.: US 2018/0240333 A1
(43) Pub. Date: Aug. 23, 2018

(54) CONTROL DEVICE, COMPUTER AND COMMUNICATION SYSTEM

(71) Applicant: BLOKS. AG, Schaan (LI)

(72) Inventor: Daniel MEERMANN, Munchen (DE)

(73) Assignee: BLOKS. AG, Schaan (LI)

(21) Appl. No.: 15/754,889

(22) PCT Filed: Aug. 26, 2016
(86) PCT No.: PCT/EP2016/070261

§ 371 Date: Feb. 23, 2018

(30) Foreign Application Priority Data
Aug. 26, 2015 (DE) 10 2015 216 345.8

(51) Int. Cl. G08C 19/00; G07C 5/00; B62J 99/00; H04L 12/40

(52) U.S. Cl. CPC G08C 19/00; G07C 5/008; B62J 99/00; H04L 2012/40273; B62J 2099/0013; B62J 2099/004; H04L 12/40

(57) ABSTRACT

The invention relates to a control device for a vehicle, in particular for a bicycle, preferably for an electric bicycle, comprising a controller and an interface for connection and communication with separate components provided on the vehicle, the controller being configured to communicate via the interface with components in such a way that the components can be programmed and/or parameterized with the aid of the control means.

Furthermore, the invention relates to a corresponding computer for communication with the control device, and to a communications system.

The invention relates to a control device for a vehicle, in particular for a bicycle, preferably for an electric bicycle, to a computer, in particular a USB host, and to a communications system.

Conventionally, in vehicles, in particular bicycles such as electric bicycles (eBikes), the electronic components installed in the vehicles are respectively configured with interfaces specifically provided for the programming and parameterization thereof.

As a result, the respective programming and parameterization complexity is increased, since the respective electronic components must each be parameterized and programmed separately by connection to a controller via the respective interface.

The object of the invention is therefore to develop the control devices, computers and communications system known from the prior art in such a manner that the programming and parameterization complexity can be reduced.

This object is achieved by the features of the independent claims.

Advantageous embodiments and developments of the invention may be derived from the dependent claims.

The control device according to the invention is intended for a vehicle, in particular for a bicycle, preferably for an electric bicycle, and comprises a controller and an interface for connection and communication with at least one separate (electronic) component provided in the vehicle, the controller being configured to communicate via the interface with the separate component in such a way that the component can be programmed and/or parameterized using the controller.

The control device according to the invention can be further developed in such a manner that the controller is configured to provide an application server and/or a web server.

Furthermore, the control device according to the invention may be configured in such a manner that the control device has a further interface, preferably a USB interface, via which preferably an IP-based communication is made possible for connection and communication with a computer, via which, by means of the control device, the programming and/or parameterization of the component can be carried out.

The computer according to the invention is in particular a USB host and comprises an interface, the computer being configured to communicate with the control device according to the invention via the interface in such a way that the separate component connected to the control device can be programmed and/or parameterized via the computer. In this instance, the computer may be a desktop PC, a component of a smartphone, tablet, etc.

The communications system according to the invention comprises the control device according to the invention, the computer according to the invention and a server for providing software package management, the server being configured in such a manner to provide, with the aid of the software package management, to the control device by means of the computer or directly to the control device, a software package, which the control device can use to program and parameterize a separate component.

The invention is concerned generally with the subject of providing a service interface/maintenance interface of a control unit for a vehicle, in particular a bicycle, preferably an electric bicycle. Service interfaces/maintenance interfaces are typically highly fragmented or widely distributed on a vehicle, for example a bicycle, preferably an electric bicycle. Thus, usually each electronic component of the vehicle has its own programming and parameterization software as well as its own physical data interface, for example in the form of a component-integrated USB socket, which results in increased programming and parameterization complexity. The invention addresses this problem. According to the invention, the various service interfaces of the respective electronic components are to be consolidated or provided in a single component, namely the control unit corresponding to the control device according to the invention. The control unit designed in such a manner accordingly has the necessary devices or mechanisms, inter alia, those devices and mechanisms for programming and for the parameterization of all the electronic components installed in the vehicle. Furthermore, the control unit may be configured to dynamically, as a function of the components installed in the vehicle, resolve dependencies between certain software versions; for example, the control unit can combine different program packages, which are mutually dependent, into one program package. For example, if for the operation of an automatic gearshift a driver (or firmware or software) is necessary, which requires a corresponding driver for an actuator compatible with the gearshift (or firmware or software), the control unit compiles a suitable combination of program packages into one new program package, matched to the installed electronic components of the vehicle. For this purpose, the most suitable combination of programmable software versions available is provided by a software package management—at the vehicle level—as a single archive file. In order for a control unit—local update manager and the remote software package management to be able to interact with one another, the control unit uses a combination of standardized communications mechanisms of modern operating systems.

### Technical Implementation of the Invention

A control unit according to the invention, which may be configured in the form of a control or check module, may be connected via an interface, such as an onboard electrical system, with other, remote electronic vehicle components (hereinafter referred to briefly as components). Likewise, the control unit may also have direct coupling so as to directly, that is, for example, without a bus-based onboard electrical system, communicate with other electronic components, for example, components for user interaction such as a display unit and/or components for external networking. For example, this direct communication is carried out on the basis of direct coupling via wired and/or wireless interfaces.

In this instance, the control unit can be configured to parameterize the components interacting therewith (for example, in connection with a bicycle lamp, the control of the brightness of the light sources thereof) and to reprogram the components by directly or indirectly calling up the remote start program (for example, a “bootloader”). When calling up the start program directly, a microcontroller (μcontroller) or microcontroller software of the control unit programs a remote microcontroller of a remote electronic component directly via the onboard electrical system or another interface, such as a serial interface (UART, SPI, I2C, etc.). In an indirect call, the microcontroller software of the control unit programs the remote microcontroller of the remote electronic component via a microcontroller acting as a proxy and protocol handler, which can be provided in an adapter device (such as a cable or harness) between the control unit and the electronic component on the vehicle.

With the help of a unique identification feature (for example, a unique serial number and a hardware and/or software version), the update manager executed on the microcontroller of the control unit detects the remote components, inter alia also their current software version, and passes this information on to a locally available application for managing software packages or via an IP-based network to an application for managing software packages, subsequently also referred to as software package management (see dpkg=Debian package manager). The software package management manages the programmable software for all the electronic components installed in the vehicle and interacting with the control unit.

The software package management is configured to detect whether a more suitable software version (as a function of the context) is available for a microcontroller or a microcontroller of an electronic component located within reach of the control unit and makes this software version available to the update manager executed on the microcontroller of the control unit for further processing.

Furthermore, software package management is configured to resolve all dependencies between the software versions of the components interacting with the control unit, as explained above, and to aggregate the various software versions to be programmed into a single archive file, which is to be loaded and extracted by the update manager.

Moreover, the software package management is configured to support the incremental loading of the archive file by the update manager or the providing of the archive file, regardless of the transport medium used.

The parameterization of the components interacting with the control unit can be carried out with and without the intervention of a user. Users may be the component manufacturer, vehicle manufacturer, fleet operator, dealer or end user.

For interaction with the user and the manual parameterization, an integrated application and web server is executed on the microcontroller of the control unit. Advantageously, the application server and web server are executed only if the operating state of the vehicle, for example the maintenance state, allows for it.

The application server (e.g. Tomcat) communicates directly with the software of the control unit or the software of the microcontroller and makes interfaces (for example, via common gateway interface) available to the web server (e.g. Apache) for generating dynamic content (HTML, JavaScript, media).

The contents generated in this way can be called up with the aid of a web browser so that the user can interact indirectly with the control unit software or the microcontroller software. The control unit itself does not require its own output (display) or input (mouse, keyboard, etc.).

The control unit has a physical interface (e.g. USB) and supports USB device classes “Mass Storage Medium” and “Ethernet over USB”. These two USB device classes are generic device classes which are integrated in every modern operating system. When the control unit is powered up to a USB host (for example, a computer or PC with Microsoft Windows), two dynamically generated files are stored by the control unit in the root directory, visible to the USB host, of the removable storage media detected by the USB host: a) an automation routine (e.g. autorun.inf) and b) the homepage (index.html) of the web server. The automation routine points to the homepage of the web server and tells the USB host that this homepage is to be executed in a web browser installed locally on the USB host. The data requested by this web browser (HTML, JavaScript, media, etc.) from the web server of the control unit are transmitted via “IP over USB.” In this instance, the web browser is offline, that is, it does not have an active Internet connection.

The locally executed applications loaded by the web browser (e.g. JavaScript) contain libraries (e.g. jQuery) for bypassing the cross-domain rules of the web browser, so that the browser application loaded by the control unit, which previously has only been locally executed, can now also make requests to a second, Internet-based service. Thus, the same browser-based application has two concurrent connections to two different servers: a) a server operated by the control unit directly interacting with the control unit software; and b) a remote, Internet-based server such as the server for the software package management. The browser application (e.g. jQuery) bridges these two connections so that the application server running on the microcontroller of the control unit, via the bridge built by the browser application, can directly make requests to arbitrary, third, Internet-based services. Communication between the server for the software package management and the control unit may thus be carried out indirectly, that is, by means of the host computer (the desktop PC, smartphone, tablet, etc.), or directly (without the interposition of a host computer or control logic).

The interfaces of the web server of the control unit are disclosed as a function of a) a defined rights model (e.g. data and functions), b) as a function of the user of the control unit (e.g. manufacturer of the control unit, vehicle manufacturer, component manufacturer, fleet operator, dealer, end customer, etc.), and c) of a suitable authentication method.

### Technical Effects and Advantages of the Invention

In order to minimize the number of redundant data interfaces on a vehicle (USB at the bicycle lamp, USB at the battery, OneWire at the electronic gearshift, etc.), these redundant data interfaces are to be consolidated and to be made available via a single component, namely the control unit corresponding to the control device according to the invention. For this purpose, the control unit provides its own user interface, which as a function of the rights of the user, provides different functions and data.

The user interface for interacting with the control unit is to be implemented as a browser-based application (e.g. HTML, JavaScript), which is automatically executed locally in the web browser of the USB host via the automation routine of the host operating system and which communicates via IP-based mechanisms (e.g. SOAP, web sockets, etc.) with the control unit, without establishing an Internet connection on its own. The web browser of the USB host remains offline and does not require any Internet connection to communicate with the control unit.

No installation of device drivers is required because the required USB device classes (Mass Storage Media, Ethernet over USB) are already supported by common host operating systems. This means that downloading or setting up drivers or providing dedicated software on physical data carriers supplementing the vehicle is no longer required.

Manually adjusting complex firewall settings, such as would be required during the local installation of an executable application (e.g. *.exe) on the USB host, are avoided because only operating system-generic mechanisms are used, which do not need any—or, if so, only minimal—firewall settings on common operating systems (use of the automation routines, use of the USB mass storage medium, use of Ethernet over USB, calling up the web browser, running a browser application, building IP-based connections).

The web server of the control unit recognizes the language setting preferred by the user on the basis of the header information (e.g. MIME type=language) of the request made by the web browser of the USB host when loading the homepage (e.g. index.html), so that the browser application is automatically executed in the language preferred by the user and the user does not initially require manual input of his preferred language.

The update manager executed by the microcontroller of the control unit, or any third-party application executed by the same microcontroller, may, using the bridge established by the browser application, interact with a remote software package management provided via the Internet or with any other third party service (e.g. persistence of master and movement data of the user or the vehicle).

A preferred embodiment of the invention is explained below by way of example with reference to the sole figure.

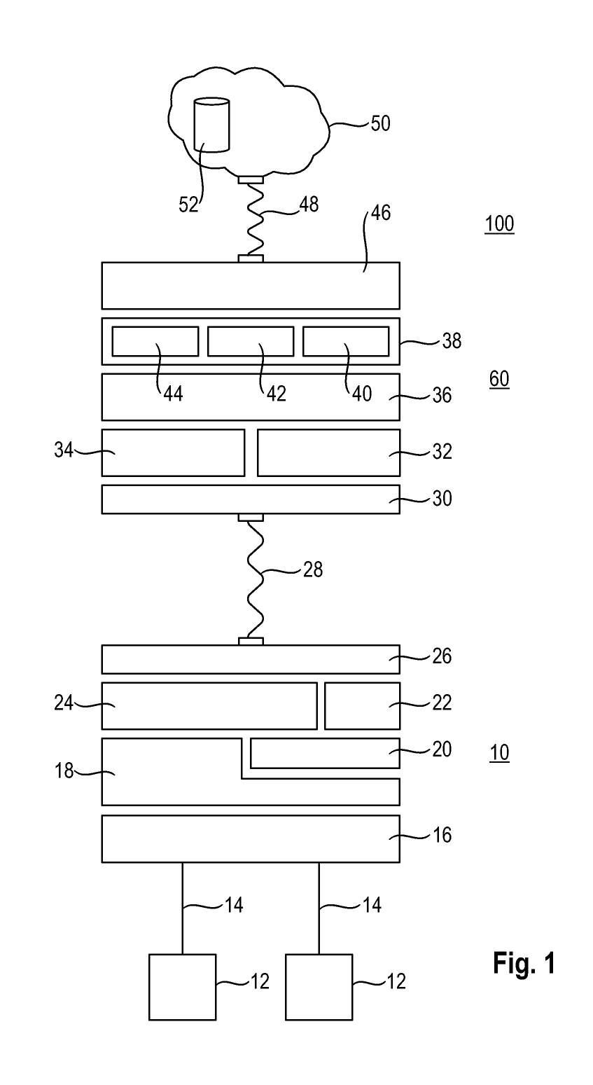

FIG. 1 schematically shows a communications system 100, the communications system 100 being illustrated by respective functions or software blocks.

The communications system 100 according to the invention has a control unit 10 corresponding to the control device according to the invention for a vehicle, in particular a bicycle, preferably for an electric bicycle, in which devices are provided via which other electronic components 12 installed in the vehicle can be programmed and parameterized. Furthermore, the control unit 10 is configured to dynamically resolve, as a function of the installed components 12, dependencies between certain software versions. For this purpose, the most suitable combination of programmable software versions available is provided by a software package management 52, described in greater detail below—at the vehicle level—as a single archive file. In order for a control unit—local update manager and the remote software package management 52 to be able to interact with one another, the control unit 10 uses a combination of standardized communication mechanisms of modern operating systems.

For this purpose, the control unit 10 according to the invention, which may be configured in the form of a control or check module, in the case shown is connected with one or a plurality of other, remote electronic vehicle components (components) 12 via an onboard electrical system 14 as an interface. Alternatively, the control unit 10 may have a direct coupling so as to communicate directly, i.e. for example without a bus-based onboard electrical system 14, with other components 12, for example components 12 for user interaction, such as a display unit (not shown) and/or components 12 for external networking. For example, the direct communication made possible by the direct coupling takes place via wired and/or wireless interfaces.

As already mentioned, the control unit 10 is configured to parameterize components 12 interacting therewith (e.g. in connection with a bicycle lamp, the control unit 10 can control the brightness of the light sources thereof) and to program or reprogram a component 12 by directly or indirectly calling up a remote start program thereof (e.g. a “bootloader”).

In calling up the start program directly, a microcontroller (μcontroller) 16 or microcontroller software 16 of the control unit 10 programs a remote microcontroller of a remote component 12 directly via the onboard electrical system 14 or another interface, e.g. a serial interface (UART, SPI, I2C, etc.).

In an indirect call, the microcontroller software 16 of the control unit 10 programs the remote microcontroller of the remote component via a microcontroller acting as a proxy and protocol handler, for example, in an adapter between the control unit and the electronic component, which can communicate with the component to be programmed and/or parameterized.

With the aid of a unique identification feature (e.g. a unique serial number and a hardware and/or software version), an update manager executed on the microcontroller 16 of the control unit 10 or executed by the microcontroller software 16 of the control unit 10 recognizes the remote components 12 and, inter alia, also the current software release status thereof, and forwards this information to a software package management application available locally or via an IP-based network, subsequently also referred to as software package management 52.

The software package management 52 manages the programmable software for all the electronic components 12 installed in the vehicle and interacting with the control unit 10.

The software package management 52 is configured to detect whether a more suitable software version (as a function of the context) is available for a microcontroller of an electronic component located within reach of the control unit 10 and makes this software version available to the update manager executed on the microcontroller 16 of the control unit 10 for further processing.

Furthermore, the software package management 52 is configured to resolve all the dependencies between the software versions of components 12 interacting with the control unit 10 and to aggregate the various software versions to be programmed into a single archive file, which is to be loaded and extracted by the update manager.

Moreover, the software package management 52 is configured to support incremental loading of the archive file by the update manager or the providing of the archive file, regardless of the transport medium used.

The parameterization of components 12 interacting with the control unit 10 can be carried out with and without the intervention of a user. Users may be the component manufacturer, vehicle manufacturer, fleet operator, dealer or end user.

For interaction with the user and for the manual parameterization, an integrated application server 18 and a web server 20 are executed on the microcontroller 16 of the control unit 10 or by microcontroller software 16. Advantageously, the application server 18 and the web server 20 are executed only if the operating state of the vehicle, for example the maintenance state, allows for it.

The application server 18 (e.g. Tomcat) communicates directly with the control unit software or the microcontroller software 16 and makes interfaces (e.g. via common gateway interface) available to the web server 20 (e.g. Apache) for generating dynamic content (HTML, JavaScript, media).

The contents generated in this way can be called up with the aid of a web browser 38 so that the user can interact indirectly with the control unit software 16 or microcontroller software 16. The control unit 10 itself does not require its own output (display) or input (mouse, keyboard, etc.).

The control unit 10 has a physical interface (e.g. USB) 26 and supports the USB device class “Mass Storage Media” 22 and the USB device class “Ethernet over USB” 24. These two USB device classes 22, 24 are generic device classes, which are integrated in every modern operating system.

Upon startup of the control unit 10 to a USB host 60 (e.g. a computer having Microsoft Windows as operating system 36), which is connected via a USB interface 30 via an IP-based connection 28 to the USB interface 26 of the control unit 10, and which has an operating system 36, the web browser 38 and an input/output interface 46 for connection to a server for the software package management 52, two dynamically generated files are stored by the control unit 10 in the root directory, visible to the USB host 60, of the removable storage media detected by the USB host 60: a) an automation routine (e.g. autorun.inf) and b) the homepage (index.html) of the web server 20. The automation routine points to the homepage of the web server 20 and tells the USB host 60 that this homepage is to be executed in a web browser 38 installed locally on the USB host 60. The data requested by this web browser 38 (HTML 42, JavaScript 44, media 40, etc.) from the web server 20 of the control unit 10 are transmitted via “IP over USB” on the basis of an IP-based connection (interface) 28. In this instance, the web browser 38 is offline, i.e. it does not have an active Internet connection.

The locally executed applications loaded by the web browser 38 (e.g. JavaScript) contain libraries (e.g. jQuery) for bypassing the cross-domain rules of the web browser 38, so that the browser application loaded by the control unit 10, which previously has only been locally executed, can now also make requests to a second, Internet-based service. Thus, the same browser-based application has two concurrent connections to two different servers: a) a server operated by the control unit 10, such as the web and application server 18, 20, which directly interacts with the control unit software 16; and b) a remote, Internet-operated server for providing the software package management 52. The browser application (e.g. jQuery) bridges these two connections so that the application server 18 executed on the microcontroller 16 of the control unit 10, via the bridge established by the browser application, can directly make requests to arbitrary, third-party, Internet-based services, such as the server for providing the software package management 52.

The interfaces of the web server 20 of the control unit 10 are disclosed as a function of a) a defined rights model (e.g. data and functions), b) as a function of the user of the control unit 10 (e.g. manufacturer of the control unit, vehicle manufacturer, component manufacturer, fleet operator, dealer, end customer, etc.) and c) of a suitable authentication method.

The features of the invention disclosed in the above description, the drawings and in the claims may be essential, both individually and in any combination, for the implementation of the invention.

### LIST OF REFERENCE NUMERALS

10 control unit

12 external components (installed in the vehicle)

14 interface (e.g. onboard electrical system)

16 microcontroller or microcontroller software

18 application server

20 web server

22 device class “Mass Storage Medium”

24 device class “Ethernet over USB”

26 USB hardware interface

28 IP-based interface

30 USB hardware interface

32 device class “Mass Storage Medium”

34 device class “Ethernet over USB”

36 operating system

38 web browser

40 data (media)

42 data (HTML)

44 data (JavaScript)

46 input/output interface

48 IP-based interface

50 Internet

52 software package management

60 computer or PC (USB host)

100 communications system

1-6. (canceled)

7. A control device (10) for a vehicle comprising a controller (16) and an interface (14) for connection and communication with at least one separate component (12) provided on the vehicle, wherein the control device (16) is configured to communicate via the interface (26) with the separate component (12) in such a way that the component (12) can be programmed and/or parameterized with the aid of the controller (16),
the control device (10) comprises a further interface (26), preferably a USB interface, via which preferably an IP-based communication is made possible for connection and communication with a computer (60), via which, by means of the control device (10), the programming and/or parameterization of the component can be carried out and the controller (16) is configured
to execute an application server (18) and a web server (20), wherein the application server is configured to make interfaces available to the web server (20) for generating dynamic contents, which contents can be called up by a web browser (38) executable on the computer (60), so that a user of the computer (60) can interact with the controller (16) for programming and/or parameterizing the component.

8. The control device as recited in claim 7, wherein
the application server (18) and the web server (20) are executable exclusively in a specific operating state of the vehicle, preferably in a maintenance state.

9. A computer (60), in particular a USB host, comprising an interface (30),
wherein the computer (60) is configured to communicate with a control device (10) for a vehicle, the control device (10) comprising a controller (16) and an interface (14) for connection and communication with at least one separate component (12) provided on the vehicle, wherein the control device (16) is configured to communicate via the interface (26) with the separate component (12) in such a way that the component (12) can be programmed and/or parameterized with the aid of the controller (16), the control device (10) comprises a further interface (26), preferably a USB interface, via which preferably an IP-based communication is made possible for connection and communication with a computer (60), via which, by means of the control device (10), the programming and/or parameterization of the component can be carried out and
the controller (16) is configured to execute an application server (18) and a web server (20), wherein the application server is configured to make interfaces available to the web server (20) for generating dynamic contents, which contents can be called up by a web browser (38) executable on the computer (60), so that a user of the computer (60) can interact with the controller (16) for programming and/or parameterizing the component;
wherein the computer (60) is configured to communicate with a control device (10) via the interface (30) in such a way that, via the computer (60), the separate component (12) connected to the control device (10) can be programmed and/or parameterized.

10. A communications system (100) comprising a control device (10) for a vehicle, a computer (60), and a server for providing a software package management (52),
the control device (10) comprising a controller (16) and an interface (14) for connection and communication with at least one separate component (12) provided on the vehicle, wherein the control device (16) is configured to communicate via the interface (26) with the separate component (12) in such a way that the component (12) can be programmed and/or parameterized with the aid of the controller (16), the control device (10) comprises a further interface (26), preferably a USB interface, via which preferably an IP-based communication is made possible for connection and communication with a computer (60), via which, by means of the control device (10), the programming and/or parameterization of the component can be carried out and the controller (16) is configured to execute an application server (18) and a web server (20), wherein the application server is configured to make interfaces available to the web server (20) for generating dynamic contents, which contents can be called up by a web browser (38) executable on the computer (60), so that a user of the computer (60) can interact with the controller (16) for programming and/or parameterizing the component.
the computer (60) in particular a USB host, comprising an interface (30), wherein the computer (60) is configured to communicate with a control device (10) via the interface (30) in such a way that, via the computer (60), the separate component (12) connected to the control device (10) can be programmed and/or parameterized, and
the server is configured, with the aid of the software package management (52) of the control device (10), to make a software package available by means of the computer (60) or directly to the control device (10), which software package can be used or is used by the control device (10) for programming and parameterizing a separate component (12).
